(19) United States
(12) Patent Application Publication
(10) Pub. No.: US 2024/0314588 A1
(43) Pub. Date: Sep. 19, 2024

(54) SYSTEM AND METHOD TO MANAGE TRANSMISSION OF A NOTIFICATION PRIOR TO USER EQUIPMENT BECOMING OUT-OF-COVERAGE

(71) Applicant: Badawi Yamine, Beirut (LB)

(72) Inventor: Badawi Yamine, Beirut (LB)

(21) Appl. No.: 18/606,341

(22) Filed: Mar. 15, 2024

(30) Foreign Application Priority Data
Mar. 16, 2023 (IN) 202341017897

(51) Int. Cl. H04W 24/02

(52) U.S. Cl. CPC H04W 24/02

(57) ABSTRACT

A method (100) to manage transmission of a notification is disclosed. The method includes allowing a user equipment to send a notification to a network at the time of losing its radio coverage. The notification sent to the network includes the primary threshold when the user equipment determines it will reach the threshold value prior to losing its radio coverage. Further, the notification is sent to the network includes secondary threshold values when the user equipment determines that the primary threshold will not be reached prior to the user equipment losing its radio coverage.

### FIELD OF INVENTION

Embodiments of the present disclosure relate to a field of cellular communications and more particularly to a system and method to manage transmission of a notification by a user equipment and a network cell.

### BACKGROUND

Every network entity whether it is a hardware entity like a radio unit or a software entity like a cell of a radio node in a mobile communication network, at a certain point of time, is subjected to an outage. There are two types of outages namely an unexpected outage that happens due to a software or hardware crash and an expected/planned outage that happens when the operator has planned, at a specific date and time, to have a software or hardware upgrade. There are several drawbacks associated with the expected/planned outage on a cell.

One such drawback of the planned outage on a cell includes when a few sensitive user equipment's are unable to communicate to a network (or send a notification to the network) when an outage has occurred. Specifically, the user equipment sends the notification to the network only when a predefined threshold has been reached when the planned outage has been executed. Additionally, the user equipment is left out of radio coverage in certain areas and is unable to communicate to the network. This could be a major problem when the user equipment carries emergency information.

Another drawback of the planned outage on a cell is that there is no method that tells the user equipment in advance under which type of area of radio coverage it will be located after the execution of the planned outage on a first cell. The location includes, but is not limited to, whether it is located under a radio coverage of a neighboring cell of a same Radio Access Technology (RAT) as of the first cell, or under a radio coverage of a neighboring cell of a different RAT than of the first cell or whether it is located in an area where there is no a radio coverage at all.

Yet another drawback of the planned outage on a cell is when a sensor embedded in a user equipment becomes activated when the user equipment is moving towards an area of out-of-coverage, then the user equipment will not send any notification to the network until it reaches 100% of the predefined threshold value. This is a problem, since by the time the sensor has reached 100% of its threshold and wants to send a notification to the network, the user equipment cannot send the notification to the network. This is because the user equipment has entered the area of out-of-coverage and hence has no signal to report the notification even when the threshold has reached 100%.

Additionally, another problem encountered is that the planned outage on a cell is not halted if by chance a sensor has become active just before the execution of the planned outage but the sensor has not reached 100% of the predefined threshold.

Hence, there is a need for an improved system and a method to manage transmission of a notification during a planned outage on a cell to address the aforementioned issue(s).

### BRIEF DESCRIPTION

In accordance with an embodiment of the present disclosure, a method at a user equipment side for managing transmission of a notification by a user equipment reaching a predefine threshold is provided. The user equipment is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold. The method includes allowing the user equipment to send a notification to a network whenever the user equipment is about to lose its radio coverage. The notification that is sent to the network includes the primary threshold when the user equipment determines that the primary threshold could be reached prior to user equipment losing its radio coverage. Further, the notification that is sent to the network includes the one or more secondary thresholds when the user equipment determines that the primary threshold could not be reached prior to the user equipment losing its radio coverage and wherein the one or more second threshold is a sub-threshold of the first threshold thereby moving from the sub-threshold to the first threshold corresponding to a time duration.

In accordance with an embodiment of the present disclosure, a method performed by a network side of a wireless communication wherein the network triggers an action based on a receipt of a notification from a user equipment during a planned outage on a cell wherein the notification is associated with the second threshold.

In accordance with an embodiment of the present disclosure, a communication network node configured for managing the transmission of notification related to a user equipment reaching a predefined threshold. The user equipment is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold. Further, the communication network node includes a processing subsystem hosted on a server and configured to execute on a network to control bidirectional communications among a plurality of modules comprising a notification module configured to allow the user equipment to send a notification to a network whenever the user equipment is about to lose its radio coverage. The notification that is sent to the network includes the primary threshold when the user equipment determines that the primary threshold could be reached prior to user equipment losing its radio coverage. Further, the notification that is sent to the network also includes the one or more secondary thresholds when the user equipment determines that the primary threshold could not be reached prior to the user equipment losing its radio coverage and wherein the one or more second threshold is a sub-threshold of the first threshold thereby moving from the sub-threshold to the first threshold corresponding to a time duration. The processing subsystem also includes a timer module configured to provide a timer value via a procedure wherein the procedure is one of the timer value hardcoded in the user equipment, the timer value set by an operator to communicate to the user equipment via signaling over air interface and the timer value calculated by a machine learning model embedded in the user equipment.

In accordance with an embodiment of the present disclosure, a communication network node is configured for receiving a notification from a user equipment by a network of a wireless communication wherein the notification includes a planned outage module configured to send a plurality of data to the serving cell wherein the plurality of data comprises an indication about the execution of the planned outage and the duration of time the user equipment has to wait wherein the duration of time is equal to the number of the cell radio subframes and its value continuously as it is deduced by one each time a cell radio subframe has been elapsed. The communication network node is also configured to send a plurality of data to the serving cell and neighboring cells wherein the plurality of data comprises and indication about the execution of the planned outage and the duration of time the user equipment has to wait wherein the duration of time is defined in unit of time. Further, the communication network node is configured to halt the event by the network in response to the event being a planned cell outage to be executed. The communication network node also includes a radio condition module configured to change the radio conditions of the user equipment in the area of out-of-coverage wherein the change in the radio conditions comprises adjusting antennas and power transmission of the serving and of neighboring cells.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a flow chart representing the steps involved in a method performed at a user equipment side for managing the transmission of a notification during a planned outage related to the user equipment reaching a predefined threshold value in accordance with an embodiment of the present disclosure;

FIG. 2 is a flow chart representing the steps involved in a method performed by a network side of a wireless communication wherein the network triggers an action based on a receipt of a notification from a user equipment wherein the notification is associated with the second threshold in accordance with an embodiment of the present disclosure;

FIG. 3 is a flow chart illustrating actions at a network of a mobile communication network before execution of a planned outage on a cell and after receiving a notification from a user equipment in accordance with an embodiment of the present disclosure;

FIG. 4 is a flow chart illustrating the user equipment sending a notification before bad radio conditions in accordance with an embodiment of the present disclosure;

FIG. 5 is a block diagram representation of a system at a user equipment side for managing the transmission of a notification related to the user equipment reaching a predefined threshold value in accordance with an embodiment of the present disclosure;

FIG. 6 is a block diagram representation of a system at a network side of a wireless communication network wherein the network triggers an action based on a receipt of a notification from a user equipment wherein the notification is associated with the second threshold in accordance with an embodiment of the present disclosure; and

FIG. 7 is a block diagram of a computer or a server for a communication network node in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In the discussion that follows, references will be made to “first cell”, “second cell” with reference to an entity (cell) in the cellular network.

Embodiments of the present disclosure relate to a system and method to manage transmission of a notification in a wireless network. A method at a user equipment side for managing transmission of a notification by a user equipment reaching a predefine threshold is provided. The user equipment is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold. The method includes allowing the user equipment to send a notification to a network whenever the user equipment is about to lose its radio coverage. The notification that is sent to the network includes the primary threshold when the user equipment determines that the primary threshold could be reached prior to user equipment losing its radio coverage. Further, the notification that is sent to the network includes the one or more secondary thresholds when the user equipment determines that the primary threshold could not be reached prior to the user equipment losing its radio coverage and wherein the one or more second threshold is a sub-threshold of the first threshold thereby moving from the sub-threshold to the first threshold corresponding to a time duration.

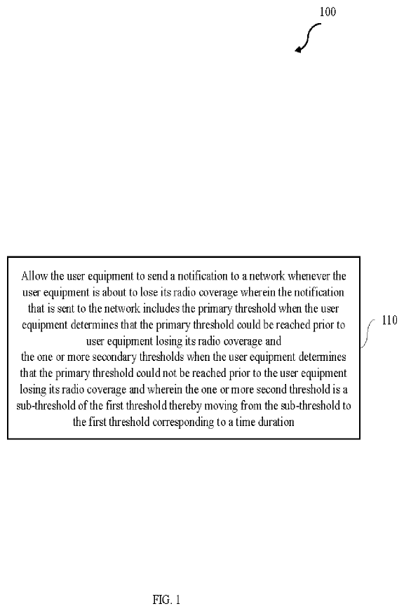

FIG. 1 is a flow chart representing the steps involved in a method (100) performed at a user equipment side for managing the transmission of a notification related to the user equipment reaching a predefined threshold value in accordance with an embodiment of the present disclosure. The user equipment is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold.

It must be noted that the primary threshold, secondary threshold and time duration of the second threshold are configured by a vendor of the user equipment or by the vendor of the sensor embedded in the user equipment.

The user equipment is allowed to send a notification in step (110) to a network whenever the user equipment is about to lose its radio coverage wherein the notification that is sent to the network includes:
1. The primary threshold when the user equipment determines that the primary threshold could be reached prior to user equipment losing its radio coverage
2. The one or more secondary thresholds when the user equipment determines that the primary threshold could not be reached prior to the user equipment losing its radio coverage and wherein the one or more second threshold is a sub-threshold of the first threshold thereby moving from the sub-threshold to the first threshold corresponding to a time duration.

It must be noted that the network is a wireless network. Further, the network comprises the preconfigured server, the operations and support system of the network, the serving and neighboring cells.

Further, the user equipment sends a notification to a preconfigured server wherein the preconfigured server is operatively coupled to the operations and support system of the network.

In one embodiment, user equipment is about to lose its radio coverage due to either the planned outage on the serving cell or an area of out-of-coverage on the serving cell. In such an embodiment, the user equipment is aware of the planned outage to be executed in response to an information communicated by the serving cell. Further, the user equipment is aware of entering an area of out-of-coverage wherein the user equipment sends a radio measurement event to the serving cell in response to unacceptable radio conditions and in response it does not receive within a timer period a handover command from the serving cell to move into the neighboring cell. Furthermore, the user equipment receives a timer value via a procedure wherein the procedure is one of the timer value hardcoded in the user equipment, the timer value set by an operator to communicate to the user equipment via signaling over air interface and the timer value calculated by a machine learning model embedded in the user equipment.

The sensor embedded in the user equipment becomes active with the second threshold at a corresponding time duration.

In one embodiment, the user equipment sends a second notification to the network prior to losing its radio coverage at the occurrence of expiry of the second threshold wherein the second notification comprises one of a third threshold or the main threshold.

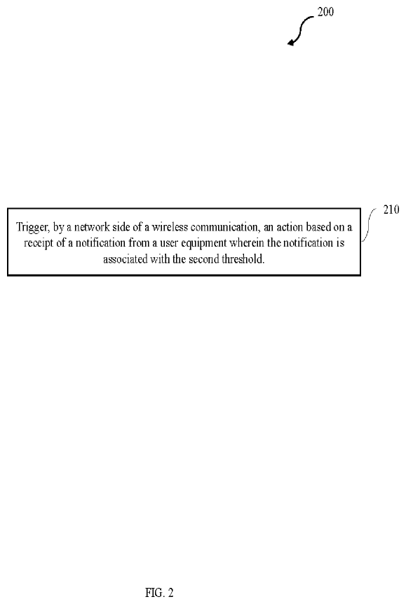

FIG. 2 is a flow chart representing the steps involved in a method (200) performed by a network side of a wireless communication wherein the network triggers an action based on a receipt of a notification from a user equipment wherein the notification is associated with the second threshold during a planned outage in accordance with an embodiment of the present disclosure. The action of the user equipment includes either halting the event by the network in response to the event being a planned cell outage to be executed. Further, the action can also include improving the radio conditions of the user equipment in the area of out-of-coverage wherein improving the radio conditions comprises adjusting antennas and power transmission of the serving and of neighboring cells in step 210.

The network communicates to the user equipment about the planned cell outage via a procedure. The procedure is to send a plurality of data to the serving cell wherein the plurality of data comprises an indication about the execution of the planned outage and the duration of time the user equipment has to wait wherein the duration of time is equal to the number of the cell radio subframes and its value continuously as it is deduced by one each time a cell radio subframe has been elapsed. Further, the procedure is to send a plurality of data to the serving cell and neighboring cells wherein the plurality of data comprises an indication about the execution of the planned outage and the duration of time the user equipment has to wait wherein the duration of time is defined in unit of time.

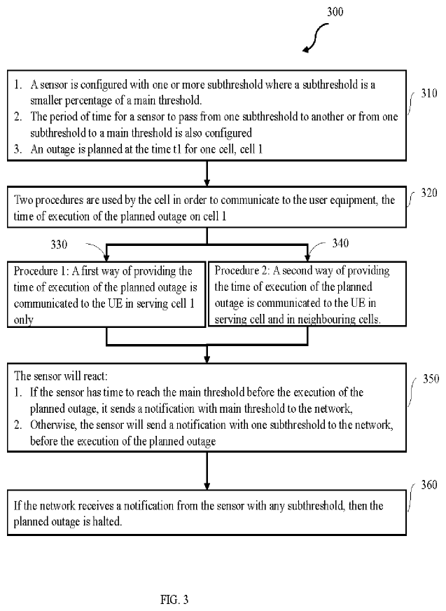

FIG. 3 is a flow chart illustrating actions of a network before execution of a planned outage and after receiving a notification from a user equipment in accordance with an embodiment of the present disclosure.

Method 1: Network actions before the execution of a planned outage on a cell and after the network receives a notification from an active user equipment before the user equipment reaches the 100% of its predefined threshold.

As a first step, the network (that is the serving cell) communicates to the user equipment the following information:
1. A planned outage of a cell by setting a new parameter to ‘1’ and denoted by planned_outage. The new parameter is received by the user equipment.
2. A precise time to execute the planned outage. The time of execution can be implicit or explicit. If the time of execution is implicit then the planned outage applies on the user equipment's serving cell and neighboring cells. However, if the time of execution is explicit then the planned outage applies only on the user equipment's serving cell and it is expressed by a plurality of radio subframes that decreases by 1 after a radio subframe has elapsed. For instance, consider at time t1, the number of radio subframes to be broadcasted before the execution of the planned outage is 12000 and the duration of each subframe is equal to 10 ms. In such a scenario, at time t1 the serving cell broadcasts the value as equal to 1200 indicating that the user equipment has to wait for 1200 radio subframes before execution of the planned outage.

As a result of the first step, the user equipment receives the new parameter (planned_outage=1) and the remaining time for the planned outage to be executed. At this time, if a sensor embedded in the user equipment has become active even though the value of the user equipment did not reach its configured 100% Thresh1 value then one of the following is performed:
a) If the user equipment finds that it has time to reach 100% of Thresh1 before the planned outage is executed, for instance at 12:00 AM, then the user equipment will wait till it reaches 100% and subsequently sends a notification to the network or,
b) If the user equipment finds that it does not have enough time to reach 100% of Thresh1 before the planned outage is executed then the user equipment sends a notification to the network even though the user equipment has reached a percentage of Thresh1, for instance 70% of Thresh1.

Further, the user equipment finds whether it has enough time to reach 100% of the Thresh1 value or not based on the user equipment's historical data and on several predefined rules that are already embedded at the sensor, for instance by the vendor of the sensor.

Consequently, when the network receives the notification from the user equipment with 70% of the Thresh1 value, the network triggers a predefined action. In a specific embodiment, the predefined action is to halt the planned outage.

Let us consider method 1. Typically, method 1 is about notifying one or more user equipment's in a cell about the time of execution of a planned outage of a cell. The initial state for method 1 includes the user equipment configured with one or more subthreshold where the subthreshold is a smaller percentage of a main threshold at step (310). Further, the period of time for a user equipment to pass from one subthreshold to another one or from one subthreshold to a main threshold is denoted as T_subthreshold_i. Furthermore, an outage is planned at time t1 for a particular cell, referred as cell 1.

There are two procedures used by the cell1 to communicate the time of the planned outage to the user equipment at step (320).

Procedure 1: When the time of the outage execution is explicit and is communicated to the user equipment serving on the serving cell, cell 1, at step (330).

The planned_outage parameter is coded in a few bits to include two pieces of information. The first piece of information is whether the planned outage is activated or deactivated. The second piece of information is the period of time the user equipment has to wait, since it reads the value of the planned_outage=1, until the planned outage is executed. In one embodiment, the period of time could be delivered as equal to the number of radio subframes that the user equipment has to wait after it has read the value of the planned_outage=1. That value of radio subframe broadcasted in the second piece of information is deduced by 1 after the elapse of each radio subframe. For instance, if the outage of cell 1 is planned at 12:00 am then planned_outage=1 is communicated to the user equipment before the execution of the planned outage for example at 11:58 pm.

Consider a user equipment, UE 1 being served at cell 1. The UE 1 will read the new broadcasted parameter planned_outage that is coded in a few bits at the time it was broadcasted. Further, the new broadcasted parameter is decoded to fetch the value of the (second information) that consists of the time the user equipment must wait from the time it reads the value of the planned_outage=1. Referring back, to the ongoing example wherein the planned outage is at 11:48 pm, the (second information) had been broadcasted at 11:58 pm and as the time of the execution of the outage is equal to 2 minutes (or 120 seconds), the (second information) could be expressed as equal to 12000 radio subframes (2 minutes=120 seconds) and as every 10 ms there is one radio subframe then in two minutes there are 12000 radio subframes. It must be noted that the value of radio subframes could be communicated via different format. In one example, it could be communicated as being a number multiple by 1000, for instance, instead of broadcasting 12000 the cell will broadcast the value of 12 and the minimum value being equal to 1. Further, it must be noted that the value of the duration of a radio subframe depends on the value being used by cell 1 and the list of possible values is already defined by the actual standards. Such value depends on the radio access technology of the serving cell, for example 4G or 5G, and on the numerology being used.

Consider another user equipment, for example UE 2, that has entered cell 1 at a later time, for example at 11:59 pm. cell1 will be broadcasting the (1st info) with planned_outage=1 and the (2nd info) as being equal to 1 mn (equal to 60 seconds) which is communicated to all UEs in cell 1, via the broadcast channel, in terms number of radio subframes (6000 radio subframes) that the UE has to wait before cell 1 is executed.

Procedure 2: When the time of the outage execution is implicit and is communicated to the user equipment being served by the serving cell, cell1, and by neighboring cells, at step 340.

Here, a new parameter, for instance planned_outage, is introduced. The said parameter may be coded into 1 bit only and is sent from the serving cell and from the neighboring cells. It must be noted that the planned_outage parameter is communicated to the user equipment either via a dedicated signaling message or preferably via the broadcasted system information. A second parameter that consists of a predefined timer is also introduced, for example, denoted as implicit_outage_timer. The value of such timer could be defined by an operator and received by the user equipment and is linked to the value of the planned_outage as follows:
1) When the user equipment receives planned_outage=1, that means for the user equipment, the outage on the serving cell will be executed after expiry of a predefined implicit_outage_timer for instance 1 minute.
2) When the user equipment receives planned_outage=0, that means that there is no planned outage to be executed soon.

Further, by defining parameter planned_outage and the timer implicit_outage_timer without adding any rules might encounter an issue. For instance, consider that the planned outage is planned at 12:00 am. In such a scenario, consider that planned_outage=1 has been broadcasted on cell1 at 11:59 pm and that implicit_outage_timer=1 minute. For a user equipment, say UE1, that was being camped on cell 1 at time 11:59 pm there is no issue as it reads at the same time that is at 11:59 pm the value of planned_outage=1 and the value of implicit_outage_timer=1 minute and it will then expect the outage to be at 12:00 am. However, if another user equipment, UE2, enters cell1 at 11h 59 minutes and 30 seconds, it will read the value of planned_outage=1 and the value of implicit_outage_timer=1 minute and as a result it will then expect the outage to be, after 1 minute from reading the value of planned_outage=1, that is at 12h 00 minute and 30 seconds which is wrong because in reality the planned outage is planned at 12:00 am.

Therefore, to avoid such the issue, the planned outage parameter is not broadcasted only at serving cell, as it was the case with the explicit Procedure 1 above, but it is also broadcasted on all neighboring cells of cell 1.

The reaction of an active user equipment after receiving planned_outage=1 at step (350). In such a scenario, the level of a smart user equipment at the user equipment has increased but it has not yet reached a predefined threshold that triggers a notification to the network. Consider that a user equipment receives the notification of a planned_outage to be executed at 12:00 am while its smart sensor is being increased by a high level of a dangerous gas (e.g. value of the sensor has reached 70% of the predefined denoted Thresh1) then, a proposed sensor feature consists of the following:
1) At the receipt of planned_outage=1, even though the value of the sensor (70% of Thresh1) did not reach its predefined Thresh1 value on which it is configured to notify the network, the smart sensor, based on its historical data or on some predefined rules that are already embedded at the sensor (for instance, by the vendor of the sensor), will behave as follows:
   a. If the user equipment finds that it has time to reach the 100% of Thresh1 before the planned outage is executed at 12:00 am, then the sensor will wait till it reaches that 100% and sends a notification to the network.
2) Otherwise, if the sensor finds that it could not reach the 100% of Thresh1 before planned outage is executed at 12:00 am, then the sensor will send a notification to the network before the outage, for instance at time 11h 59 mn 30 seconds, even though it has reached a percentage of Thresh1, for instance 70% of Thresh1.

As long as the planned outage is not executed and if any T_subthreshold_i expires, the sensor will send another notification containing another subthreshold or main threshold. Such a scenario might occur when, for example, T_subthreshold_i is shorter than the duration to wait by the sensor for the planned outage to be executed.

Further, when the network receives a notification from a user equipment after the planned_outage has been set to 1, the network either reacts on whether procedure 1 or procedure 2 has been performed.

Let us consider the case wherein the procedure 1 has been performed. In such scenario, planned_outage=1 is broadcasted only at cell 1. Therefore, when the network receives from any user equipment located in cell 1, for instance sensor 1, a notification at 70% of Thresh1, then the network reacts in a way to deal in a best way with such notification. For example, when the network receives the notification of 70% of Thresh1 from sensor1 it will halt the planned outage. The halt is done so that sensor can send another notification when it reaches the 100% of Thresh1. It must be noted that the ‘halt’ is a unique feature of the present disclosure.

Now let us consider the case where procedure 2 has been performed. In such a scenario, planned_outage=1 is broadcasted at cell 1 and at neighboring cells surrounding cell 1. Therefore, when the network receives from any user equipment a notification at 70% of Thresh1, the network reaction will depend on whether the notification is coming from a user equipment that is located at cell 1 or that is located in a neighboring cell. If the user equipment (say sensor 1) is located at the serving cell (cell 1) and if the notification is about 70% of Thresh1, then the network will halt the planned outage. The halt is done so that the sensor could send another notification when it reaches the 100% of Thresh1. Likewise, if the user equipment (say sensor 2) is located at the neighbouring cell and if the notification is about 70% of Thresh1, then the network would react depending on the user equipment's mobility. In such a case, if the user equipment (sensor 2) is stationary, the network will not take any further action. For instance, it will not halt the planned outage on the cell 1. This is because cell 2 will not go into the planned outage (only cell 1 will go into an outage) and therefore sensor 2 could still send a notification to cell 2 when it reaches 100% of Thresh1. However, if the user equipment (sensor 2) is moving towards cell 1, then in one embodiment, the network will halt the planned outage (360) because sensor 2 may reach cell 1 and in particular an area of out of coverage of cell 1, after the execution of cell1 outage and before reaching the 100% Thresh1. In another embodiment, if the user equipment (sensor 2) is not moving towards cell 1, the network will not halt the planned outage. In such an embodiment, no action is taken as sensor 2 will not be impacted by the outage on cell 1 and therefore it could send a second notification to the network when it reaches 100% of Thresh1.

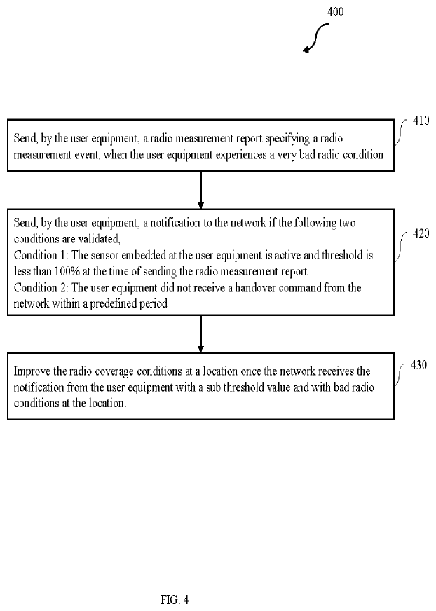

FIG. 4 is a flow chart illustrating the user equipment sending a notification before bad radio conditions during a planned outage in accordance with an embodiment of the present disclosure. Method 2: The user equipment sends out its notification beforehand in case it is moving to an out-of-coverage area.

### Method 2

In this scenario, the user equipment sends a notification to the network when the 100% value of a predefined threshold Thresh1 has been reached.

Further, method 2 allows the user equipment to send a notification to the network when the value of the user equipment has not reached the 100% of Thresh1, for instance when it reaches 70% of Thresh1, only during two conditions. The two conditions includes:
1. Condition 1: A particular radio measurement event, for example event A2, is triggered at the time when the level of the sensor did not reach 100% of Thresh1, for example at 70% of Thresh1.
2. Condition 2: The user equipment did not receive, within a predefined period, for instance T_wait, a handover command from the network.

In other words, if the above two conditions are not verified, the user equipment has only one option to send the notification to the network when the user equipment has reached 100% of Thresh1. Further, if the user equipment has reported such a notification at a location X, a network reaction consisting of taking an action to improve the radio conditions at location X, for example by making serving cell 1 or neighboring cells increase temporary the power level of their radio transmission.

Let us consider method 2. The user equipment sends the notification beforehand when radio conditions are bad. The initial state of method 2 involves the user equipment configured with one or more subthreshold wherein the one or more subthreshold is a smaller percentage of a main threshold. Further, the period of time for a sensor to pass from one subthreshold to another one or from one subthreshold to a main threshold is also configured and denoted by T_subthreshold_i.

Typically, method 2 consists of three steps. The first step occurs when the user equipment or sensor experiences very bad radio conditions, based on actual wireless standards it sends to the network, in particular to the serving cell, a Radio Resource Control (RRC) measurement report containing a radio measurement event, for instance event A2, in step (410).

The second step occurs if the following two conditions are validated in step (420):
1. Condition 1: At the time of sending the Radio Resource Control (RRC) measurement report (in the above mentioned first step) the user equipment is active but the level of the sensor did not reach 100% of Thresh1, for example at 70% of Thresh1.
2. Condition 2: The user equipment did not receive, within a predefined period, for example, denoted by T_wait, a handover command from the network, then the user equipment will send a notification to the network in particular to server_for_sensors along with the following information:
   a. The notification is sent at 70% of the predefined Thresh1 and it is not sent at 100% of Thresh1.
   b. The reason for sending the notification at 70% Thresh1. One reason could be a cell planned outage is being broadcasted as it is the case with method 1 described above. Another reason as it is the case with method 2 here is when the UE is experiencing very bad radio conditions.
   c. The geographical location X of the sensor at time of sending the notification.

An example of procedures that might be used for setting the value of T_wait:
1—The value of T_wait could be given in advance to the user equipment by the vendor, for example the value of T_wait is hardcoded in the memory of the user equipment by the user equipment vendor.
2—The value of T_wait could be given to the user equipment by the operator, for example the value of T_wait could be communicated to the user equipment by the cell to the user equipment by adding a new parameter T_wait to existing dedicated RRC signalling or to existing cell broadcasted System Information Block (SIB).
3—The value of T_wait could be calculated by the user equipment via a new AI (Artificial Intelligence) or ML (Machine Learning) entity implemented at the user equipment and that could estimate the value of T_wait based on previous radio measurement reported events, for instance by calculating the minimum, average and maximum periods that takes to receive the handover command after the user equipment has sent a radio measurement event to the network.

The third step includes the user equipment sending another notification as long as the user equipment does not lose its radio coverage and if and T_subthreshold_i expires. The notification includes another subthreshold or main threshold. Such scenario might occur when for example T_subthreshold_i is shorter than the duration to wait by the sensor to enter the area of out-of-coverage.

Further, the server_for_sensors will send a notification to the OSS, informing it about the presence of a sensor at cell1 that is experiencing very bad radio conditions and that it has reached 70% of its predefined Thresh1. One of method 2 objectives consists of making the OSS react to such notification in a way, for example to improve the radio coverage of cell 1 at location X, for example by increasing the level of the radio transmission power of the antennas of cell 1 or by adjusting the antennas of neighboring cell, for example by triggering SON features on neighboring cells. The purpose of making the network react in a way to improve the radio coverage at location X is to avoid the sensor losing its radio coverage especially before it has reached the 100% of Thresh1 as the sensor might be in urgent need in such situations at step (430).

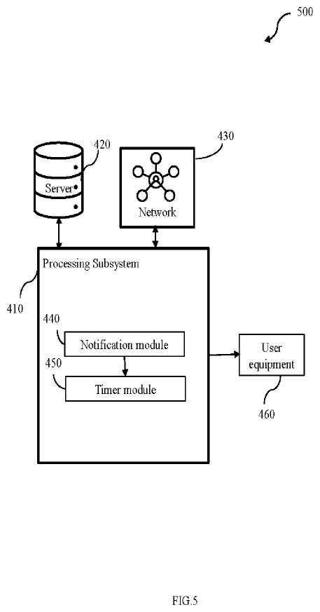

FIG. 5 is a block diagram representation of a system (400) at a user equipment side for managing the transmission of a notification related to the user equipment reaching a predefined threshold value in accordance with an embodiment of the present disclosure. As used herein, the interaction between the user equipment and the network cell may include unidirectional communications, and bi-directional communications that may happen between the network cell and the user equipment when the user equipment is moving between different network cells or being stationary in the network cell. Further, the user equipment is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold.

The system (400) includes a processing subsystem (410). The processing subsystem (410) is hosted on a server (420). In one embodiment, the server (420) may be a cloud-based server. In another embodiment, the server (420) may be a local server. The processing subsystem (410) is configured to execute on a network (430) to control bidirectional communications among a plurality of modules. Furthermore, in one embodiment, the network (430) may include one or more terrestrial and/or satellite networks interconnected to communicatively connect a user device to web server engine and a web crawler.

Further, in one example, the network (430) may include communications over a terrestrial cellular network, including, GSM/EDGE (global system for mobile communications/(enhanced data for global evolution)), 4G, 5G, coming 6G, CDMA (code division multiple access) network. In yet another embodiment, the network (430) may also be a private or public local area network (LAN) or wide area network (WAN), such as the internet. Further, in another embodiment, the network (430) may include both wired and wireless communications according to one or more standards and/or via one or more transport mediums. In one example, the network (430) may include wireless communications according to one of the 802.11 or Bluetooth specification sets, LoRa (Long Range Radio) or another standard or proprietary wireless communication protocol.

Furthermore, the processing subsystem (430) includes a notification module (440) configured to allow the user equipment (460) to send a notification to a network (430) whenever the user equipment (460) is about to lose its radio coverage. The notification that is sent to the network (430) includes a primary threshold when the user equipment (460) determines that the primary threshold could be reached prior to user equipment (460) losing its radio coverage. The notification also includes the one or more secondary thresholds when the user equipment (460) determines that the primary threshold could not be reached prior to the user equipment losing its radio coverage and wherein the one or more second threshold is a sub-threshold of the first threshold thereby moving from the sub-threshold to the first threshold corresponding to a time duration.

Further, the processing subsystem (410) includes a timer module (450) configured to provide a timer value via a procedure wherein the procedure is one of the timer value hardcoded in the user equipment (460), the timer value set by an operator to communicate to the user equipment (460) via signaling over air interface and the timer value calculated by a machine learning model embedded in the user equipment (460).

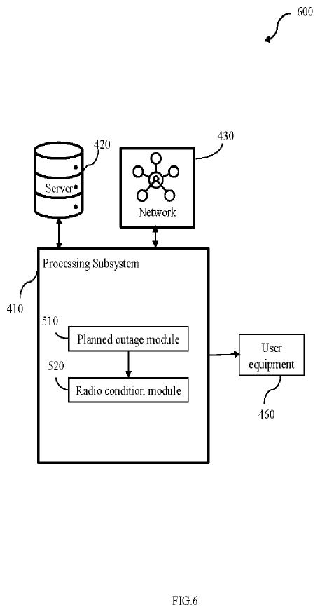

FIG. 6 is a block diagram representation of a system (500) at a network side of a wireless communication wherein the network triggers an action based on a receipt of a notification from a user equipment wherein the notification is associated with the second threshold in accordance with an embodiment of the present disclosure.

The system (500) includes a planned outage module (510) configured to send a plurality of data to the serving cell wherein the plurality of data comprises an indication about the execution of the planned outage and the duration of time the user equipment (460) has to wait wherein the duration of time is equal to the number of the cell radio subframes and its value continuously as it is deduced by one each time a cell radio subframe has been elapsed.

Further, the planned outage module (510) is configured to send a plurality of data to the serving cell and neighboring cells wherein the plurality of data comprises and indication about the execution of the planned outage and the duration of time the user equipment has to wait wherein the duration of time is defined in unit of time.

Furthermore, the planned outage module (510) is configured to halt the event by the network (430) in response to the event being a planned cell outage to be executed.

The system (500) also includes a radio condition module (520) configured to change the radio conditions of the user equipment (460) in the area of out-of-coverage wherein the change in the radio conditions comprises adjusting antennas and power transmission of the serving and of neighboring cells.

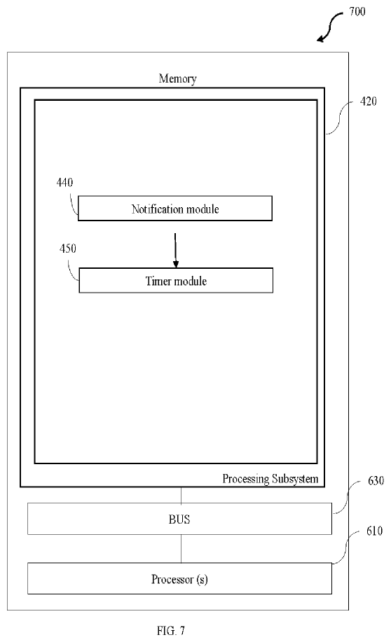

FIG. 7 is a block diagram of a computer or a server for a communication network node in accordance with an embodiment of the present disclosure. FIG. 7 is a block diagram of a computer or a server in accordance with an embodiment of the present disclosure. The server (420) includes processor(s) (610), and memory (420) operatively coupled to the bus (630). The processor(s) (610), as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (420) includes several subsystems stored in the form of executable program which instructs the processor to perform the method steps illustrated in FIG. 1. The memory (420) is substantially similar to system (100) of FIG. 1. The memory (420) has the following subsystems: the processing subsystem (420) includes a notification module (440) and a timer module (450). The bus (630) as used herein refers to be the internal memory channels or computer network that is used to connect computer components and transfer data between them. The bus (630) includes a serial bus or a parallel bus, wherein the serial bus transmit data in bit-serial format and the parallel bus transmit data across multiple wires. The bus (630) as used herein, may include but not limited to, a system bus, an internal bus, an external bus, an expansion bus, a frontside bus, a backside bus, and the like.

The notification module (440) is configured to allow the user equipment to send a notification to a network whenever the user equipment is about to lose its radio coverage. The notification that is sent to the network includes a primary threshold when the user equipment determines that the primary threshold could be reached prior to user equipment losing its radio coverage. The notification also includes the one or more secondary thresholds when the user equipment determines that the primary threshold could not be reached prior to the user equipment losing its radio coverage and wherein the one or more second threshold is a sub-threshold of the first threshold thereby moving from the sub-threshold to the first threshold corresponding to a time duration.

The timer module (450) is configured to provide a timer value via a procedure wherein the procedure is one of the timer value hardcoded in the user equipment, the timer value set by an operator to communicate to the user equipment via signaling over air interface and the timer value calculated by a machine learning model embedded in the user equipment.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable programs stored on any of the above-mentioned storage media may be executable by the processor(s) (210).

Various embodiments of the system and method to manage transmission of a notification during a planned outage described above enables various advantages. The method includes the sensor able to send beforehand, under certain conditions, a notification to the network, for example before the value of its alarm threshold has reached 100% of a predefined threshold. For example, the sensor could send in advance a notification about an alarm, when one of the below two events have occurred:
1. at the time of the execution of the planned outage
2. or when the sensor is experiencing very bad radio conditions and did not receive a handover command

It will be understood by those skilled in the art that the foregoing general description and the following detailed description are exemplary and explanatory of the disclosure and are not intended to be restrictive thereof. While specific language has been used to describe the disclosure, any limitations arising on account of the same are not intended.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all the acts need to be necessarily performed. Also, those acts that are not dependent on other acts may be performed in parallel with the other acts. The scope of embodiments is by no means limited by these specific examples.

We claim:

1. A method (100) performed at a user equipment side for managing the transmission of a notification related to the user equipment reaching a predefined threshold wherein,
the user equipment is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold comprising:
allowing the user equipment to send a notification to a network whenever the user equipment is about to lose its radio coverage wherein the notification that is sent to the network comprises:
the primary threshold when the user equipment determines that the primary threshold could be reached prior to user equipment losing its radio coverage; and
the one or more secondary thresholds when the user equipment determines that the primary threshold could not be reached prior to the user equipment losing its radio coverage and wherein the one or more second threshold is a sub-threshold of the first threshold thereby moving from the sub-threshold to the first threshold corresponding to a time duration.

2. The method (100) as claimed in claim 1 wherein the user equipment is about to lose its radio coverage due to one of the planned outage on the serving cell and an area of out-of-coverage on the serving cell.

3. The method (100) as claimed in claim 2 wherein the user equipment is aware of the planned outage to be executed in response to an information communicated by the serving cell.

4. The method (100) as claimed in claim 2 wherein the user equipment is aware of entering an area of out-of-coverage wherein the user equipment sends a radio measurement event to the serving cell in response to unacceptable radio conditions and in response it does not receive within a timer period a handover command from the serving cell to move into the neighboring cell.

5. The method (100) as claimed in claim 4 wherein the user equipment receives a timer value via a procedure wherein the procedure is one of the timer value hardcoded in the user equipment, the timer value set by an operator to communicate to the user equipment via signaling over air interface and the timer value calculated by a machine learning model embedded in the user equipment.

6. The method (100) as claimed in claim 1 wherein a sensor embedded in the user equipment becomes active with the second threshold at a corresponding time duration.

7. The method (100) as claimed in claim 1 wherein the first threshold, second threshold and time duration of the second threshold are configured by a vendor of the user equipment or by a vendor of the sensor embedded in the user equipment.

8. The method (100) as claimed in claim 1 wherein the network is a wireless network.

9. The method (100) as claimed in claim 1 wherein the user equipment sends a second notification to the network prior to losing its radio coverage at the occurrence of expiry of the second threshold wherein the second notification comprises one of a third threshold or the main threshold.

10. The method (100) as claimed in claim 1 wherein the user equipment sends a notification to a preconfigured server wherein the preconfigured server is operatively coupled to the operations and support system of the network.

11. The method (100) as claimed in claim 1 wherein the network comprises the preconfigured server, the operations and support system of the network, the serving and neighboring cells.

12. A method (200) performed by a network side of a wireless communication wherein the network triggers an action based on a receipt of a notification from a user equipment wherein the notification is associated with the second threshold.

13. The method (200) as claimed in claim 12 wherein the action and the event experienced by the user equipment comprises one of:
halt the event by the network in response to the event being a planned cell outage to be executed; and
improve the radio conditions of the user equipment in the area of out-of-coverage wherein improving the radio conditions comprises adjusting antennas and power transmission of the serving and of neighboring cells.

14. The method (200) as claimed in claim 13 wherein the network communicates to the user equipment about the planned cell outage via a procedure wherein the procedure is one of:
send a plurality of data to the serving cell wherein the plurality of data comprises an indication about the execution of the planned outage and the duration of time the user equipment has to wait wherein the duration of time is equal to the number of the cell radio subframes and its value continuously as it is deduced by one each time a cell radio subframe has been elapsed; and
send a plurality of data to the serving cell and neighboring cells wherein the plurality of data comprises an indication about the execution of the planned outage and the duration of time the user equipment has to wait wherein the duration of time is defined in unit of time.

15. A communication network node (500) configured for managing the transmission of notification related to a user equipment (460) reaching a predefined threshold,
wherein the user equipment (460) is configured with a plurality of thresholds corresponding to a plurality of time durations wherein the plurality of thresholds comprises a primary threshold and one or more secondary thresholds and wherein the plurality of time durations indicates the time periods at which the user equipment is required to move between the one or more secondary thresholds or between the one or more secondary thresholds and the primary threshold comprising:
a processing subsystem (410) hosted on a server (420) and configured to execute on a network (430) to control bidirectional communications among a plurality of modules comprising:
a notification module (440) configured to allow the user equipment (460) to send a notification to a network (430) whenever the user equipment (460) is about to lose its radio coverage wherein the notification that is sent to the network (430) comprises:
the primary threshold when the user equipment (460) determines that the primary threshold could be reached prior to user equipment (460) losing its radio coverage; and
the one or more secondary thresholds when the user equipment (460) determines that the primary threshold could not be reached prior to the user equipment (460) losing its radio coverage and wherein the one or more second threshold is a sub-threshold of the first threshold thereby moving from the sub-threshold to the first threshold corresponding to a time duration; and
a timer module (450) configured to provide a timer value via a procedure wherein the procedure is one of the timer value hardcoded in the user equipment (460), the timer value set by an operator to communicate to the user equipment (460) via signaling over air interface and the timer value calculated by a machine learning model embedded in the user equipment (460).

16. A communication network node (600) configured for receiving a notification from a user equipment (460) by a network (430) of a wireless communication comprising:
a planned outage module (510) configured to:
send a plurality of data to the serving cell wherein the plurality of data comprises an indication about the execution of the planned outage and the duration of time the user equipment (460) has to wait wherein the duration of time is equal to the number of the cell radio subframes and its value continuously as it is deduced by one each time a cell radio subframe has been elapsed; and
send a plurality of data to the serving cell and neighboring cells wherein the plurality of data comprises and indication about the execution of the planned outage and the duration of time the user equipment (460) has to wait wherein the duration of time is defined in unit of time; and
halt the event by the network (430) in response to the event being a planned cell outage to be executed; and
a radio condition module (420) configured to change the radio conditions of the user equipment (460) in the area of out-of-coverage wherein the change in the radio conditions comprises adjusting antennas and power transmission of the serving and of neighboring cells.
